(19) United States
(12) Patent Application Publication
(10) Pub. No.: US 2011/0313924 A1
(43) Pub. Date: Dec. 22, 2011

(54) METHOD AND SERVICE COMPUTER AND SYSTEM FOR TRANSACTING A MONETARY AMOUNT

(75) Inventors: Michael Carell, Paderborn (DE); Bernd Graw, Paderborn (DE); Dirk Bradler, Paderborn (DE); Dominik Hirt, Paderborn (DE); Wolfgang Bergschneider, Paderborn (DE)

(73) Assignee: WINCOR NIXDORF INTERNATIONAL GMBH, Paderborn (DE)

(21) Appl. No.: 12/919,088

(22) PCT Filed: Feb. 25, 2009
(86) PCT No.: PCT/EP2009/052197

§ 371 Date: Nov. 22, 2010

(30) Foreign Application Priority Data
Feb. 26, 2008 (DE) 10 2008 011 192.9

(51) Int. Cl. G06Q 40/00

(52) U.S. Cl. 705/43

(57) ABSTRACT

A method and a system with a service computer (SRV) for transacting a monetary amount (AOM) from an account of a first person (A) to an automated teller machine (ATM) for cash payment of the monetary amount (AOM) to the first person (A) or to a second person (B), wherein the transaction is carried out by way of a transaction service that is administered by the service computer (SRV), wherein the first person (A) is optionally assigned an access code (MCPIN) that is transmitted by the first person (A) to the service computer (SRV) for the use of the transaction service, and wherein a connection from the service computer (SRV) to the automated teller machine (ATM) is made for releasing the cash payment, and wherein at least one telecommunication number (APN, BPN) is also transmitted from the first person (A) to the service computer (SRV), said telecommunication number being used by the service computer (SRV) for sending a report (CNF, INF) through a telecommunication service (SMS) to at least one of the persons (A, B). This allows the account holder in particular and/or the recipient to be directly informed via short messaging (SMS), for example. The account holder (A) himself can arrange the transaction and release of the cash payment quickly, easily and safely by sending an (SMS) message to the service computer (SRV). The service computer (SRV) in turn can authenticate both the account holder (A) and the recipient (B) using the telecommunication numbers reported to the service computer.

### CROSS-REFERENCE TO RELATED APPLICATIONS

This application is a National Stage of International Application No. PCT/EP2009/052197, filed Feb. 25, 2009. This application claims benefit and priority of German application 10 2008 011 192.9, filed Feb. 26, 2008. The entire disclosures of the above applications are incorporated herein by reference.

### BACKGROUND

This section provides background information related to the present disclosure which is not necessarily prior art.

### TECHNICAL FIELD

The invention relates to a method for transacting a monetary amount and relates to a service computer executing said method and further relates to a system being equipped therewith.

### Discussion

Methods for transacting monetary amounts between accounts of different persons as well as devices or systems thereof are well known. Further to this there are devices or systems well known which are designed as automated teller machines or cash points which provide cash payments, wherein the cash payment is usually executed for that person who is also the owner or holder of the bank account.

In DE 10 2005 050 605 A1 a method and a system for transacting and cashing an amount of money at an automated teller machine is disclosed. The transaction of the monetary amount is made from the bank account of a person which is also the owner of said account and is executed at an automatic teller machine where this person may receive the cash payment of the money after release. The transaction and the release of the amount of money is performed by means of online banking or telephone banking via appropriate communication links or connections. For this purpose the account holder establishes an online and/or telephone connection to a device which can be designed as a service computer or server in order to initiate or trigger a transaction or release for cash payment at the at least one automated teller machine. For this purpose data will be sent to the service computer by the account holder via online or telephone connections, said data contains information about the owner's account and about the transferred or cashed amount of money. The account holder may then achieve the cash payment of the monetary amount at any automatic teller machine which is connected to the service computer, wherein he/she will achieve this by identifying himself/herself at the automatic teller machine, for example by means of a bank customer card, and/or by authenticating himself/herself per request of biometric data or a like. With this proposed solution a customer friendly transaction and cash payment of a monetary amount can be achieved at any automated teller machine. However, it is desirable to improve a method for transacting and payout of an amount of money such that the cash payment of the monetary amount may not only be paid to the account holder but also, very required, to third persons. For this purpose it should be possible that the account holder can preferably also make use of present online or telephone connections in order to trigger the transaction and/or the release of the cash payment.

### SUMMARY OF THE INVENTION

Therefore it is an object of the present invention to improve a method of the previously mentioned type and to resolve the previously mentioned drawbacks. Further to this a service computer executing said method and a system being equipped therewith shall be provided.

Accordingly a method for transacting a monetary amount from an account of a first person to an automated teller machine for cash payment of the monetary amount to the first person or to the second person is proposed, wherein the transaction is carried out by way of a transaction service that is administered by the service computer, and wherein a connection from the service computer to the automated teller machine is set up for releasing the cash payment, wherein also at least one telecommunication number is transmitted by the first person to the service computer, said telecommunication number being used the service computer for sending a message or import wire a telecommunication service to at least one of said persons.

The proposed service computer or server performs or executes the transaction of the amount of money, wherein the first person also transmits at least one telecommunication number to the service computer, said telecommunication number is then used by the service computer for sending via the telecommunication service a message to at least one of said persons. The proposed system is equipped with such service computer and with an automated teller machine connected thereto, both being means for performing the execution of the transaction of the monetary amount as well as the cash payment.

With the method of the preferred embodiment of the invention and by means of the proposed service computer as well as the system equipped therewith the transaction of the amount of money is performed per transmission of at least one telecommunication number which is used by the service computer in order to inform at least one of the persons, particularly the account holder and/or the recipient, about of the cash payment of the monetary amount. The messaging may be made via a telecommunication service which can be e.g. a mobile short text messaging service (so-called Short Message Service). The transmitted telecommunication numbers can for example be mobile phone numbers which are assigned to the first persons and/or to the second person by the mobile telecommunication terminal. But not only mobile phone numbers can be used as telecommunication numbers, also fixed subscriber numbers, IP-addresses for interne communication, in particularly for VoIP or WLAN telephony etc. can be used. Accordingly the service computer can send messages being addressed to the participating persons depending on the telecommunication numbers which have been transmitted, said messages can particularly be short messages (SMS message) for confirming the registration or the log in to the transaction service. The messages can also be information messages for the recipient which have the form of short messages including information about the release of a cash payment and about the sum of the monetary amount and which are directly send to the respective mobile terminal. The invention achieves a very customer friendly and flexible execution of transactions and release of cash payments from a first person particularly to a second person or a stranger. Thus, the account holder can with the help of the invention e.g. trigger a transaction via the transaction service being described here by sending a SMS message which then leads to the release of the cash payment at any automated teller machine, wherein the recipient can get the released amount of money at the automated teller machine directly and without needing to have an own account. The service computer can by means of the transmitted telecommunication number identify or authentificate the account holder or holder at the begin of the transaction, for example by sending to him/her a confirmation message request and can also identify or authenticate the recipient when accessing the automated teller machine by sending him/her a confirmation message or request.

Accordingly it is advantageous if the respective telecommunication number particularly indicates or marks a mobile telecommunication terminal which is assigned to the first or second person. In this context it is advantageous if the at least one telecommunications number is used for an authentication of the first or second person by means of the assigned telecommunication terminal. Thus the telecommunication numbers being communicated to the system cannot only be used for performing telecommunications, such as automatic messaging for persons or subscribers, but can also be used for a complete or partial authentification of a specific person as such. For example, the first and/or second person authenticates himself/herself by sending from his/her mobile terminal data or requests to the system. As the mobile terminal or device is unambiguously assigned to said person, the system can verify by means of the signalized telephone number when receiving the data, whether the data or requests really originate from said person. The telecommunication number quasi also serves as identification or authentification characteristic of the specific person.

For further safety of the authentification also an access code can be assigned to the first person, the access code being communicated or transmitted by the first person to the service computer for using the transaction service. In this context it is advantageous if said access code and said at least one telecommunication number are transmitted via the same telecommunications service, in particular via a mobile short message or SMS service.

There is especially an advantage if each telecommunication number indicates a specific telecommunication terminal, in particular a mobile terminal which is assigned to the first or second person, respectively. Thus the invention is qualified for realizing a mobile communications network or service which can preferably be designed as a short message service or SMS service. With this the concerned persons are enabled to perform said service or transaction at any time by using their mobile phones.

It is also advantageous if the access code and the first telecommunication number is communicated or transmitted by the first person to the service computer for using the service, said telecommunication number indicating a first telecommunication terminal, in particular a mobile terminal which is assigned to the first person. Thus the registration or log-in procedure for using said transaction service can be made by communicating data via a mobile phone.

It is also advantageous if the access code and a second telecommunication number is communicated or transmitted by the first person to the service computer or server for initiating or triggering the transaction of the monetary amount, said telecommunication number indicating a second telecommunication terminal, in particular a mobile terminal which is assigned to the second person. In this context there is a further advantage if an information about the sum of the monetary amount is transmitted by the first person together with said second telecommunication number to the service computer for triggering the transaction of the monetary amount. Thus the initiation or execution of the transaction will also considerably be made easier by using the communication or transmission of data via mobile phone(s).

Further to this, it is advantageous if beside the access code also the second telecommunication number and/or the sum of the monetary amount is transmitted by the first person via a short message service to the service computer for triggering the transaction of the monetary amount. Thus a transaction can already be started by using a single short message or SMS and the account holder just needs to send said single short message.

There is also an advantage if a transaction number for executing said transaction is communicated by the service computer to the first person, said transaction number is particularly communicated via a short message service. In this context it is advantageous if said transaction number is communicated to the second person by or from the first person via said short message service. Thus the transmission of the number being substantial for the transaction, namely the transaction number, is made by the system via a short message service and is also made otherwise by a short message service. Accordingly the transaction number can first be transmitted within the system from the server to the account holder or holder who then communicates said transaction number via another SMS to the desired recipient who in turn sends said transaction number also via SMS to the system when using the automated teller machine for the release and payment of the monetary amount. Thus the involved persons again only need to us their mobile phones in order to achieve safe transaction and payment of the money. The transaction number itself is only valid for said specific transaction, so that any spying by hacking will be useless and each attempt of fraud will be without success.

Likewise it is advantageous if the service computer communicates, preferably by short messaging, to the first person a list of indexed transaction numbers for executing several transactions.

It is also advantageous if said for releasing the cash payment of the monetary amount to the second person the service computer checks, whether said second person specifies or inputs the correct second telecommunication number which has been communicated to the service computer by the first person for messaging and authentification of the second person. In this context it is advantageous if, for releasing the cash payment of the monetary amount, said second telecommunication number is transmitted to the service computer or to an automated teller machine being connected thereto, by the second person using the second mobile telecommunication terminal, in particular by transmission via a mobile short message service or via a wireless communication interface such as Bluetooth interface. Thus the second telecommunication number serves as a means for safe authentification of the recipient and for verifying whether he/her is authorized for receiving the payment of the money. For this purpose the transmission of the telecommunication number can be made by again using preferably SMS or Bluetooth.

The invention can be realized in an advantageous manner if the communicated telecommunication numbers are e.g. mobile phone numbers, a fixed subscriber numbers, IP addresses for internet communication, wherein said IP addresses in particular relate to VoIP or WLAN telephony or to e-mail communication or to instant messaging. Thus the users of the method and system being proposed here can use the modern communications services and terminals, in particular mobile subscriber terminals.

In this context it is advantageous if the server comprises at least a device, such as a modem and/or transmitter, for being connected to a mobile network, a fixed or landline network, an IP network. Within a database being connected to said server or service computer there are at least stored, for the person using the transaction service, the access number or code and the respective telecommunication number which are assigned to said person. Further to this there are preferably stored in said database at least the telecommunication number for and of the person to whom the monetary amount shall be paid, wherein said telecommunication number is being assigned to said person. In this context it is advantageous if there is stored in said database at least a transaction number for said transaction of the monetary amount, wherein said transaction number is assigned to said transaction related to said telecommunication number. Thus there are preferably stored in said database all relevant data and infatuation for executing said transaction and release of the amount of money, wherein the logical assignment or allocation of the actual transaction data, such as account number, sum of money, transaction number and access number/code for the service are, according to the invention, linked to communicated telecommunication numbers such as mobile phone numbers of the account holder and of the recipient. Such a logical combination or allocation allows comprehensive possibilities for realizing the method being proposed here.

Finally, it has also an advantage if the automated teller machine or cash point comprises at least an interface for wireless near-field communication with a mobile telecommunication terminal. Thus the authentification of the recipient can directly be made at the machine for release and payment of the money, wherein the recipient just has to use his/her e.g. Bluetooth compliant mobile terminal.

### BRIEF DESCRIPTION OF THE DRAWINGS

The above mentioned and further advantages of the invention will be disclosed in the following by means of a detailed description of embodiments wherein reference is made to the accompanied FIGS. which show the following.

The drawings described herein are for illustrative purposes only of selected embodiments and not all possible implementations, and are not intended to limit the scope of the present disclosure.

FIG. 1 shows in a schematic drawing the exchange of information or data between the first person and components of the system to register or log-in for the described transaction service.

FIG. 2 shows in a schematic drawing the transmission of information or data between the first and second persons as well as between them and the concerned system components for performing a transaction according to the invention.

FIG. 3 represents a schematic flow chart showing the detailed steps of the matter according to the invention.

Corresponding reference numerals indicate corresponding parts throughout the several views of the drawings.

### DETAILED DESCRIPTION OF THE PREFERRED EMBODIMENTS

Example embodiments will now be described more fully with reference to the accompanying drawings.

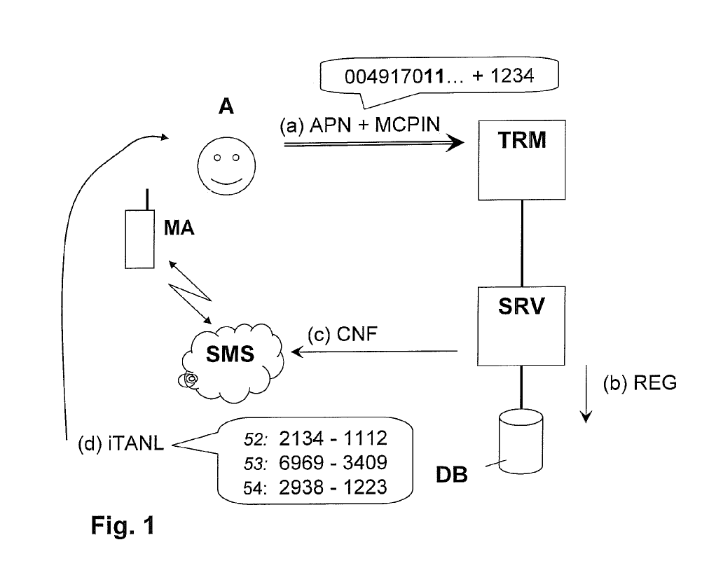

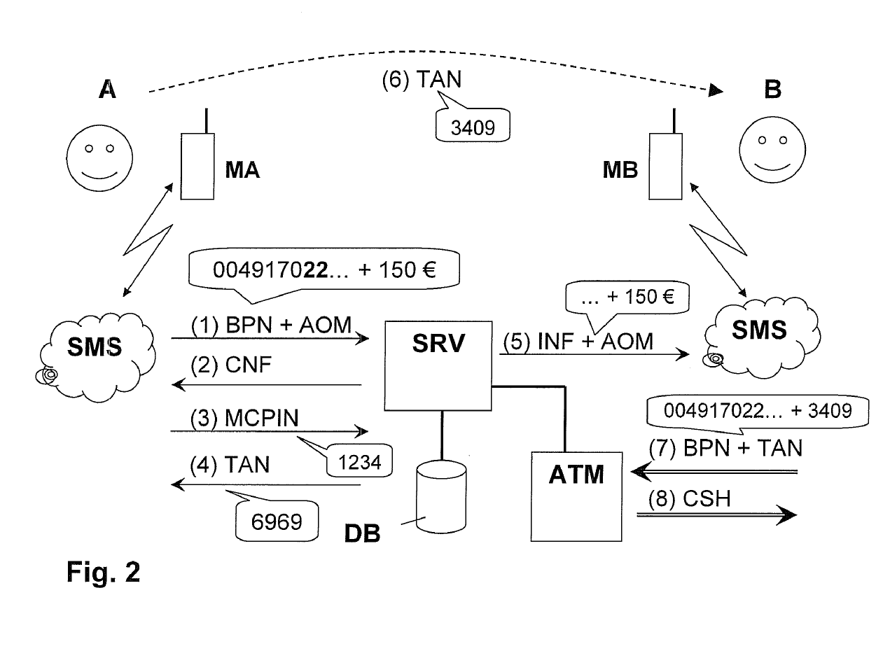

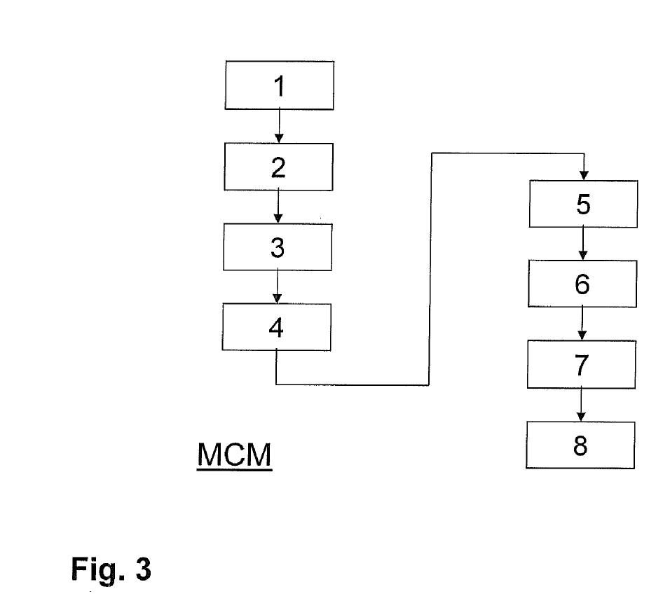

The FIG. 1 illustrates in a schematic drawing the procedure or scenario for registering the first person A in order the use the transaction service for executing a transaction of a monetary amount from an account of said first person A towards a cash payment to a second person B who is e.g. a foreigner, wherein the system of the invention is accessed. This system comprises, in particular, a service computer SRV which performs or controls the registration and also the actual transaction and which therefore receives information or messages from person A and sends messages to this person. The registration illustrated here in FIG. 1 is made prior to the method for transacting the monetary amount, the method being described in more detail by means of FIGS. 2 and 3.

At first the registration of the first person A for using the transaction service will be described here with reference to FIG. 1. The first person A also represents the account holder or holder who wants to initiate a cash payment of a certain amount of money to a second person. At first the registration is performed e.g. via a tenninal TRM which is connected to the service computer SRV and which can be a customer terminal or also a personal computer. The registration can also be made at any other terminal device. The first person A has access to a mobile communication terminal MA in order to receive messages from the service computer SRV. The registration will then be perfoli led as follows:

At first the first person A inputs in a first step (a) at least his/her own telephone number APN into the terminal TRM. In this example the telecommunication number represents the personal mobile phone number of the first person A which may have e.g. the digit sequence “004917011 . . . ”. Already with this number the system could identify or authenticate said person A. This is because, in mobile communication networks, the mobile radio number is uniquely assigned to one person. This assignment is administrated by the mobile service provider. If the system relies on this assignment and therefore accepts the provider as a trust center, an authentication of a person can already be performed by means of said mobile phone number. Because of the fact that in typical communication or data transmissions the mobile radio number will also be signalized anyway, the person could also be authenticated very quickly e.g. by sending an SMS or the like.

For further safety, the present system also uses a special access number MCPIN which is assigned to the respective person and which is requested for registration. The access number MCPIN is a personal identification or PIN code and may be e.g. “1234”. This code authorizes person A to use the transaction service. Both parts of information are then transmitted from the terminal TRM to the service computer SRV for example via a conventional telecommunications network. In a further step (b) the input data are processed by the service computer and are recorded for registration REG of this person A in a database DG which is connected to the service computer or are updated with local data. In the embodiment shown here, the person A is a customer of a bank and has an account there. Therefore the person A simply needs to input or to deposit within the system his/her mobile phone number APN and the access code MCPIN.

The service computer or server SRV then transmits in a step (c) a confirmation message CNF via the short message service SMS to the specific mobile phone number APN. This is for checking whether this specific telecommunication number is correct or not. In this way an authentication of the customer A is perfoinied during the registration for the transaction service. The confirmation message of the server SRV may also contain a request according to which the customer A is asked to answer with sending a reply SMS to the system. If this is the case the registration REG will be completed.

After a successful registration the system can communicate to the customer an individual transaction number and can in a step (d) output e.g. a list of several indexed transaction numbers iTANL which enables the customer to initiate several transactions. The transaction number or the list iTANL may also be transmitted via the telecommunication service SMS. Alternatively or in addition to this it can also be performed via any other service such as e-mail or letter post. When the registration is completed the system is prepared to executed the desired transactions.

By means of the FIGS. 2 and 3 there will be described in more detail and as an example the transaction of a monetary amount from a first person A who is e.g. a customer or account holder to a second person B who presently is a third person or recipient. The system basically comprises the service computer SRV which is connected to the database DB and which can also set up connections to at least one automatic teller machine or cash point ATM. Further to this, the service computer SRV comprises devices or interfaces, these are not shown here, to communicate via the telecommunications network SMS in order to send messages or information to participating persons or to receive data from them. The method for transacting a monetary amount, the method being performed by the system, will be described here in more detail and by each of its steps with the help of FIG. 3:

The method MCM starts with the first step (1) in which the first person A transmits a short message SMS, originating from his/her her mobile phone MA, to the server SRV, wherein this message contains the mobile phone number of the recipient BPN as well as an information about the sum of the money AOM to be transferred. For example the mobile phone number BPN is “004917022 . . . ” and the sum which shall be transferred is e.g. 150 Euros. With this information the server SRV is then triggered to start the transaction. In a second step (2) the server therefore sends back at first a confirmation message CNF to the first person A. This is also made within the framework of short message transmissions SMS. By means of this message the first person A is requested to communicate the required access code MCPIN or to input it at the terminal. This messaging is then perfoinied in the next step (3) again via the said short message service SMS. The access code MCPIN may be e.g. “1234”.

By means of the message CNF the first person A is requested by the system to confirm the transaction, wherein such a message CNF can be e.g.: “Please confirm the money transfer of 150 Euros related to telephone number “004917022 . . . ” by inputting your access code MCPIN”. Because of safety reasons it could be that only parts of the access code MCPIN will be requested such as e.g. the first or the third digit of the access code.

If the correct MCPIN is input or submitted the server SRV will detect, that the first person A is allowed to use the transaction service and then triggers in step (4) the transmission of the transaction number TAN to the first person A. This transaction number TAN can be e.g. “6969” and can also be transmitted via the SMS service. Alternatively the first person may also have already a list of transaction numbers (see iTANL in FIG. 1).

In a further step (5) the server SRV sends to the second person B, i.e. to the recipient, a message which contains the general information INF as well as information about the sum of the monetary amount AOM. The general information INF infoinis the recipient B that he/she can be in funds of the money or amount determined by the sender A and that he/she can receive the cash payment of said amount at certain automatic teller machines. The message being transmitted in step (5) can be for example: “You are in funds of the amount of 150 Euros to be received at the automatic teller machines of the XY bank.”

In order to give the recipient B real access to the money, he/she needs to have also the transaction number TAN. He/she may get this number from person A for example in a step (6) by communicating it on the phone or by transmitting an e-mail or preferably also by sending an SMS. The recipient B is then enabled to let pay the cash with the predetermined amount at the certain ATM or at any other automatic teller machine. For this purpose the recipient B simply needs to go to the teller machine and to input there in a step (7) his/her mobile phone number BPN as well as the transaction number TAN via the keyboard (PIN-Pad). Thus the release and the cash payment of the money can be achieved very quickly and straight forwardly. A card reading device is also not required.

It is also possible, that as an alternative option or in addition to the input via the keyboard at the automatic teller machine the user or recipient may also input the mobile phone number BPN and the transaction number TAN at his/her mobile phone or retrieves it there and then sends it e.g. via Bluetooth interface to the automatic teller machine or to the system. This can also be performed by a SMS message to the server SRV. Thus the recipient B would only need to carry along his/her mobile phone MB. The input at the keyboard of the automatic teller machine ATM or rather the execution of a polling menu or the like can be omitted, and also the need of a display and/or a keyboard at the automatic teller machine ATM could be omitted.

A card reading device is required in no case of those mentioned before. Therefore the proposed procedure is particularly qualified to prevent efficiently from attempts of fraud, in particular from attempts made by skimming or card frauds, or from attempts of phishing or of online interception identification data. Further to this, there is the advantage that the recipient B himself/herself needs not to have a bank account. Thus the method and system being described enables an account holder to put cash money at the disposal of any person who then can directly fetch it at an automatic teller machine. For example immigrant workers could, with the help of this method, provide their families with cash money in their home countries directly and without effort, wherein the family members do not need to have an account at a certain bank. Also the payment of pocket money for children can be performed and realized in a controllable manner by means of this method.

If the account holder or bank customer A, as shown in FIG. 1, is provided with a list of indexed transaction numbers iTANL, this list can also consist of pairs of numbers. For example the list may have the following pairs of numbers (also see FIG. 1): “2134-1112”, “6969-3409” and “2938-1223”. If it is intended to place money at somebody's disposal, the system requests the bank customer A to use the TAN-pair which is listed e.g. at the index or order number “53”, this means the pair of TANs “6969-3409”. Both TANs are valid for one and the same transaction, wherein the digit combination “6969” is assigned to the first person A (for the start of the transaction) and wherein the second digit combination “3409” is assigned to the second person B (for completing the transaction or cash payment).

Thus the bank customer or client, here the first person A, firstly sends a short message SMS with the first part of the number couple, i.e. with the digit series “6969” to the server SRV in order to confirm the start of the transaction. The server SRV then confirms by SMS message whether the transaction number was correct or not. Subsequently the first part of the transaction number couple, in this example the digits “3409”, can be transmitted to the recipient of the money, i.e. to person B. For executing the cash payment at the automated teller machine ATM this person B is then asked to input said digits “3409” or to transmit them by SMS or Bluetooth.

As long as the transaction is not completed a cancellation of the transaction can be made at the end of the account holder or the person A. This can be achieved very fast and simple by the invention if the person A just sends a further message, e.g. a SMS to the service computer SRV, wherein the message comprises the corresponding transaction number and a specific character sign, for example “#6969”. The service computer or server SRV then immediately cancels this transaction and optionally informs none or only one or even both of the participating persons A and/or B.

The method being described here and the service computer and the system are in particularly qualified to perform a quick or safe transaction as well as the payment of cash money by simply using SMS messages. The concerned persons do only need to possess mobile phones in order to use the described service. The request, release and payment of money at any automated teller machine by use of mobile radio telecommunication introduce several implementations which have been illustrated in terms of the examples given in the above description.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

1. A method of transacting a monetary amount from an account of a first person to an automated teller machine for cash payment of the monetary amount to the first person or to a second person, wherein the transaction is carried out by way of a transaction service that is administered by a service computer, and wherein a connection from the service computer to the automated teller machine is set up for releasing the cash payment,
comprising, wherein at least one telecommunication number is transmitted by the first person to the service computer, said telecommunication number being used by the service computer for sending a message or report via a telecommunication service to at least one of said persons.

2. The method of claim 1, wherein the telecommunication number particularly indicates or identifies a mobile telecommunication terminal which is assigned to the first or second person.

3. The method of claim 2, wherein the at least one telecommunication number is used for an authentication of the first or second person by means of an assigned telecommunication terminal.

4. The method of claim 1, wherein an access code is also assigned to the first person, said access code being transmitted by the first person to the service computer for using the transaction service.

5. The method of claim 4, wherein said access code and said at least one telecommunication number are transmitted via the same telecommunications service using a mobile short message service.

6. The method of claim 1, wherein an access code and/or a first telecommunication number is transmitted by the first person to the service computer for using a service, said telecommunication number indicating a first telecommunication terminal, in particular a mobile terminal which is assigned to the first person.

7. The method of claim 1, wherein an access code and/or a second telecommunication number is transmitted by the first person to the service computer for initiating or triggering the transaction of the monetary amount, said telecommunication number indicating a second telecommunication terminal, in particular a mobile terminal which is assigned to the second person.

8. The method of claim 7, wherein an information about the sum of the monetary amount is transmitted by the first person together with said second telecommunication number to the service computer for triggering the transaction of the monetary amount.

9. The method of claim 7, wherein said access code, said second telecommunication number and/or said sum of the monetary amount is transmitted by the first person to the service computer for triggering the transaction of the monetary amount.

10. The method claim 1, wherein a transaction number for executing said transaction is communicated by the service computer to the first person, said transaction number is particularly communicated via a short message service.

11. The method of claim 10, wherein said transaction number is communicated to the second person by or from the first person via said short message service.

12. The method of claim 1, wherein a list of indexed transaction numbers for executing a plurality of transactions is communicated by the service computer to the first person, said list is particularly communicated via a short message service.

13. The method of claim 1, wherein the first person or the second person inputs at the automated teller machine a first or second telecommunication number respectively and said transactions number for the release of the cash payment of the monetary amount by keyboard input at the automated teller machine.

14. The method of claim 13, wherein before releasing the cash payment of the monetary amount to the first person the service computer checks, whether said first person specifies or inputs the first telecommunication number which is known by the service computer or has been communicated by the first person.

15. The method of claim 7, wherein before releasing the cash payment of the monetary amount to the second person the service computer checks, whether said second person specifies or inputs the second telecommunication number which has been communicated by the first person to the service computer for communicating it to the second person.

16. The method of claim 15, wherein before releasing the cash payment of the monetary amount said second telecommunication number is transmitted by the second person and originating from the second mobile telecommunication terminal (MB) to the service computer, in particular is transmitted via a mobile short message service or a wireless communication interface such as a Bluetooth interface.

17. The method of claim 1, wherein said at least one telecommunication number being transmitted is a mobile phone number, a fixed network number, an IP address for internet communication, in particular for VoIP or WLAN telephony or for e-mail communication or instant messaging.

18. A service computer for executing a transaction of a monetary amount from an account of a first person to an automated teller machine for cash payment of the monetary amount to the first person or to a second person, wherein the transaction is carried out by way of a transaction service that is administered by the service computer, and wherein the service computer sets up a connection to the automated teller machine for releasing the cash payment, comprising, wherein said first person communicates to the service computer also at least one telecommunication number which is used by the service computer for sending a message or report via a telecommunication service to at least one of said persons.

19. The service computer of claim 18, wherein said service computer is configured to perform the steps of the method of claim 1.

20.-32. (canceled)

33. The service computer of claim 18, wherein said service computer comprises at least a device for being connected to a mobile phone network, a fixed subscriber network, an IP network, in particular the internet.

34. A system comprising a service computer for executing a transaction of a monetary amount from an account of a first person to an automated teller machine for cash payment of the monetary amount to the first person or to a second person, wherein the transaction is carried out by way of a transaction service that is administered by the service computer, and wherein the service computer sets up a connection to the automated teller machine for releasing the cash payment,
comprising, wherein said first person communicates to the service computer also at least one telecommunication number which is used by the service computer for sending a message or report via a telecommunication service to at least one of said persons.

35. The system of claim 34, wherein said service computer is configured to perform the steps of the method of claim 1.

36.-37. (canceled)

38. The system of claim 34, wherein said system comprises a database being connected to said service computer, wherein for the person using said transaction service there are at least said access code and said telecommunication number which are assigned to said person and are stored in said database.

39. The system of claim 38, wherein in said database there is stored at least the telecommunication number for and of the person to who the monetary amount is paid, said telecommunication number being assigned to said person.

40. The system of claim 38, wherein in said database there is stored at least a transaction number for said transaction of the monetary amount, said transaction number being assigned to said transaction.

41. The system of claim 34, wherein in said automated teller machine comprises at least an interface for wireless near-field communication with a mobile telecommunication terminal.
